(19) United States
(12) Patent Application Publication
(10) Pub. No.: US 2022/0248898 A1
(43) Pub. Date: Aug. 11, 2022

(54) SYSTEM AND METHOD FOR PRODUCING AN EXTRACT

(71) Applicant: LRP AG, Thun (CH)

(72) Inventors: Markus Widmer, Thun (CH); Thomas Liebe, Thun (CH)

(73) Assignee: LRP AG, Thun (CH)

(21) Appl. No.: 17/614,299

(22) PCT Filed: Jun. 2, 2020
(86) PCT No.: PCT/EP2020/065243

§ 371 Date: Nov. 24, 2021

(30) Foreign Application Priority Data
Jun. 4, 2019 (CH) 00714/19

(51) Int. Cl. A47J 31/56; A47J 31/52; A47J 31/46; A47J 31/10

(52) U.S. Cl. CPC A47J 31/56; A47J 31/5253; A47J 31/5255; A47J 2202/00; A47J 31/461; A47J 31/468; A47J 31/10; A47J 31/5251

(57) ABSTRACT

A system and method for producing an extract from an extraction material by means of an extraction agent comprises a supply line for the extraction agent, a heating device, a brewing device for the extraction material and an extract collection container. The supply line contains a measuring element and at least one volumetric flow control element for the volumetric flow of the extraction agent. In addition, the temperature of the heated extraction agent can be measured by means of the measuring element. The system comprises a control unit, the control unit containing a dosage regime for the heated extraction agent for the brewing device. The dosage regimen can be selected by means of an input device, whereby the volumetric flow control element can be set according to the dosage regimen and is monitored via the measuring element.

### TECHNICAL FIELD

The present invention relates to a system and a method for producing an extract from an extraction material by means of an extraction agent. The system can comprise a device for preparing hot beverages, such as coffee, tea, cocoa beverages. Hot beverages can also be understood to mean other liquid foodstuffs that are heated, for example soups, which can be consumed in the form of a drink.

### DESCRIPTION OF RELATED ART

From the document DE 10 20 11 076 116 A1 a coffee machine is known which has a boiler which is connected to a water tank, a drip tray, a drain, or a dispensing point via a line having a valve and a pump. In the stand-by state, the valve is at least partially open, as a result of which an open boiler system is obtained. The valve is actuated and closed by a control unit when a drink is drawn off so that hot water is needed. As soon as the desired predefined operating pressure is reached, the valve, which is configured as a pressure relief valve, opens, such that the hot water, which has been prepared for coffee preparation, can be fed to a brewing device for preparing a coffee beverage at the operating pressure. The amount of cold water fed to the boiler can be determined by means of a flow meter, which is located in the feed line to the boiler between the water tank and the boiler. The use of an open boiler system for stand-by operation and a volume flow-controlled beverage dispenser have the advantage of reducing energy consumption. The pressure relief valve also serves as a safety valve and therefore an additional safety valve is not required. The temperature of the hot water leaving the boiler and the amount of hot water that is provided for preparing the coffee drink are not regulated in any way. Presumably, the user has to interrupt the operation of the pump by pressing a switch or push button as soon as the coffee beverage is ready. The user cannot influence the hot water temperature or the pressure of the hot water supplied to the brewing device, which means that these parameters remain uncontrolled in a conventional system.

The beverages can therefore only be prepared using a more or less constant temperature, and this temperature can decrease or increase in an uncontrolled manner in the course of the preparation, depending on the process—thus, depending on the selected device concept.

Heating times of considerable length to heat the water to the required temperature are needed when using a boiler, so that the user has to wait a long time for his drink.

When using a boiler, a predefined amount of water is heated, regardless of the amount expected by the user for the preparation of his drink. As a result, too much water is heated and additional energy is consumed, which leads to a considerable waste of energy.

When using such a coffee machine with a check valve, the water must be brought to the boil in order to generate the necessary opening pressure for the valve so that it can be transported from the boiler to the brewing device. This means that the brewing temperature cannot be selected with this concept.

There is therefore a need for an improved system for preparing hot beverages, by means of which the temperature, the volume or the brewing process can be adjusted. The adjustability of the parameters temperature, volume or brewing process enables dynamic beverage production. This means that each beverage can be produced individually, since the parameters mentioned can be selected or preset as desired.

### OBJECT OF THE INVENTION

The object of the invention is to provide a system for producing an extract from an extraction material by means of an extraction agent and in a method for producing an extract from an extraction material by means of an extraction agent, in which the temperature of the extraction agent can be set more precisely. In particular, the system and the method can be used to prepare hot beverages with the possibility to regulate the brewing temperature.

The object of the invention is also to provide a system for producing an extract from an extraction material by means of an extraction agent and in a method for producing an extract from an extraction material by means of an extraction agent, by means of which a temperature profile for the extraction agent can be set. In particular, the system and the method can be used to prepare hot beverages with the possibility to control the brewing process.

### SUMMARY OF THE INVENTION

The object of the invention is achieved by a system according to claim 1.

Advantageous embodiments of the system are the subject matter of claims 2 to 18. The object of the invention is achieved by a method according to claim 19. Advantageous embodiments of the method are the subject matter of claims 20 to 31. An advantageous use of the system or the method is the subject of claim 32.

If the term “for example” is used in the following description, this term relates to exemplary embodiments and/or variants, which is not necessarily to be understood as a more preferred application of the teaching of the invention. The terms “preferably”, “preferred” are to be understood in a similar manner by referring to an example from a set of exemplary embodiments and/or variants, which is not necessarily to be understood as a preferred application of the teaching of the invention. Accordingly, the terms “for example”, “preferably” or “preferred” can relate to a plurality of exemplary embodiments and/or variants.

The following detailed description contains various embodiments for the system according to the invention. The description of a particular system is to be regarded as exemplary only. In the description and claims, the terms “contain”, “comprise”, “have” are interpreted as “including, but not limited to”.

A system for producing an extract from an extraction material by means of an extraction agent comprises a supply line for a continuous supply of the extraction agent, a heating device, a brewing device, and an extract collection container. The brewing device contains the extraction material. The supply line is configured to supply the extraction agent to the heating device. A connection line is provided for the heated extraction agent from the heating device to the brewing device. The brewing device contains a receiving element for the extraction material, which is permeable for the extraction agent, so that an extract can be obtained by contact of the heated extraction agent with the extraction material. The extract collection container is configured to collect the extract.

The supply line or the connecting line contains at least one measuring element and at least one volumetric flow control element. A control unit is provided which contains at least one dosage regimen for the heated extraction agent for the brewing device, the dosage regimen being selectable by means of an input device. The volumetric flow control element can be set according to the dosage regimen and monitored via the measuring element.

With the present system it is possible to precisely set and monitor the quality of the extract by precisely setting the parameters pressure, temperature, and volumetric flow for the entire duration of the extraction process. In addition, a large number of dosage regimens can be stored in the control unit. For each of the dosage regimens, the duration of the extraction process, the temperature, the pressure, and the volumetric flow of the extraction agent are specified so that the extraction process takes place under precisely defined conditions.

In particular, an opening time of the volumetric flow control element can be determined from the desired volumetric flow or the pressure by means of the control unit. The extraction process can thus be set for any desired volumetric flow. In addition, the extraction process can be programmed; in particular, it is possible to extrapolate an extraction process for a desired volumetric flow from extraction processes with known volumetric flows. Therefore, according to an embodiment, the control unit contains a computing unit, a comparison unit, and a memory unit. In particular, the memory unit contains the dosage regimens, preferably containing a plurality of dosage regimens. The user of the system thus has the option of making a selection from a plurality of dosage regimens that have already been checked in order to obtain an extract of the desired quality.

The dosage regimen can in particular contain the desired volumetric flows, pressures and the desired temperatures of the extraction agent or the heated extraction agent for the preparation of the extract.

In addition, it can be checked during the extraction process whether the parameters correspond to the dosage regimen at any point in time during the extraction process. For this purpose, the measured volumetric flow value can be compared with the desired volumetric flow by means of the comparison unit. As an alternative or in addition thereto, the measured pressure value can be compared with the desired pressure by means of the comparison unit. In addition, according to an embodiment, a heating controller can be provided for controlling the heat supply to the heating device. According to an embodiment, the desired volumetric flow can be added as a disturbance variable.

According to an embodiment, the measuring element can be configured as a flow measuring device for determining a measured volumetric flow value or as a pressure measuring device for determining a measured pressure value of the extraction agent or the heated extraction agent.

The volumetric flow control element can in particular be configured as a two-way valve, a control valve, a multi-way valve or a pump. According to an embodiment, the supply line can contain the control valve or the pump. The pump can in particular be configured as a controllable pump. According to an embodiment, the connection line can contain the multi-way valve, in other words, according to this embodiment, the multi-way valve is arranged in the connection line.

According to an embodiment, a volumetric flow control element for determining a volumetric flow of the extraction agent is arranged in the supply line. The supply line contains a control valve. A control unit is provided, the control unit comprising a computing unit, a comparison unit, and a memory unit. The memory unit contains a plurality of dosage regimens which contain the desired volumetric flows and the desired temperatures of the extraction agent for the production of the extract. One of the dosage regimens can be selected by means of an input device, which includes the desired volumetric flow and the desired temperature of the heated extraction agent. The opening time of the control valve can be determined by the computing unit from the desired volumetric flow, whereby the measured volumetric flow value can be compared with the desired volumetric flow by the comparison unit, so that the control valve can be set in such a way that the desired volumetric flow matches the measured volumetric flow value.

The control valve can be controlled by the control unit in such a way that the control valve is closed when the measured volumetric flow value corresponds to the volume or volume fraction of the heated extraction agent which is to be supplied to the brewing device.

For the preparation of a hot beverage, the volumetric flow can also be split into a plurality of partial volumetric flows if the preparation is to take place in several phases. In each phase that is not a resting phase, the brewing device is supplied with a partial volumetric flow of the heated extraction agent, which comprises a volumetric flow portion of the volumetric flow. Each of the volumetric flows of the extraction agent is supplied to the heating device. The corresponding heat demand is calculated for each volumetric flow. The heating energy required to meet the heat demand is supplied to the heating device. The heating energy is determined by the computing unit of the control unit on the basis of the volume specified in the dosage regimen. The volume means in this context the volume of the extraction agent that is required for the production of the extract.

The required temperature and volume can also be set manually by the user. As an alternative or in addition to this, the volume and the temperature can be preset by the user for the production of a specific extract. The volume results from the measured value for the flow rate or the volumetric flow (e.g., ml/s) times the flow duration t (s). The volume therefore corresponds to the volume of the extraction agent. The temperature required manually for the production of a certain extract and the required volume can be stored in the memory unit as a new dosage regimen.

A plurality of different dosage regimens can be stored in the memory unit, which is to say the temperatures and volumes for the production of different extracts.

The dosage regimens for the production of an extract can also comprise a plurality of temperatures and/or comprise a plurality of volumes. A plurality of temperature gradients and/or a plurality of flow gradients can also be required for the production of an extract.

Each of the dosage regimens can be linked to a specific extract, which is to say exactly one type of extract can be produced with a specific dosage regimen. The user can select the desired extract from a plurality of extracts by means of the input device and confirm this selection on the input device.

Alternatively, the user can create a dosage regimen, which is to say a data record, for the production of any desired extract by entering the desired temperature and the desired volume using the input device and storing this data record in the memory unit. The dosage regimen can comprise a plurality of temperatures or temperature profiles. The volume can comprise a plurality of volume portions, so that a volume portion can be fed to the brewing device in each phase of the extraction process.

Thus, the primary control controls the volumetric flow. If the dosage regimen, for example the recipe for the production of the hot beverage, specifies a volume, the volumetric flow corresponding to this volume is set to the setpoint value by means of the primary control circuit, which includes the control valve, the flow measuring device and the control unit, for example by means of a PID controller.

The secondary control circuit contains a heating controller for the heating device, which can also be configured as a PID controller. With this PID controller, the volumetric flow that is currently measured, i.e., the resulting volumetric flow set by the control unit, is applied as a disturbance variable, and this heating controller can therefore react very quickly and precisely.

According to this variant, the extraction agent can be metered to the heating device by supplying a plurality of volume portions to the heating device. This dosage has the advantage that only the extraction agent needed for the next extraction process or for the next partial step of an extraction process is heated. As a result, only the energy required for heating is required and consumed, so that the energy consumption of the system can be optimized.

The temperature can be selected as required for each volumetric flow. The temperature can be constant or vary for each volumetric flow, for example a temperature gradient can be selected. A temperature gradient includes a temperature increase or a temperature decrease. According to an embodiment, the temperature can be adjustable by means of the input device. The input device can comprise an element from the group consisting of a display device with a touchscreen, a rotary switch, a slide.

According to an embodiment, the flow measuring device can comprise a digitization unit for converting the measured volumetric flow value into a digital signal. In particular, the digital signal from the flow measuring device can be transmitted to the control unit wirelessly or via cable. The digital signal can be processed by the control unit. In particular, the computing unit can assign an amount of heat to the measured volumetric flow value of the extraction agent determined by means of the flow measuring device to be supplied to this volumetric flow, which corresponds to the amount of heat to be supplied to the heating device to obtain the desired temperature.

According to an embodiment, the heating device contains a heating agent for supplying the amount of heat to the extraction agent. The heating device can contain heating elements for heating the extraction agent. The amount of heat supplied is set in particular to match the temperature of the heated extraction agent in the brewing device to the desired temperature.

According to an embodiment, the heating device comprises a flow heater. A defined volume of extraction agent can be heated to a desired temperature by the flow heater at any time. The volume is set by controlling the opening time and the volumetric flow that flows through the control valve. The amount of heat required for the desired temperature can be precisely calculated at any time for the selected flow by means of the control unit and fed to the flow heater. A very precise temperature control is thereby obtained even if the volumetric flow of the extraction agent is not constant.

According to an embodiment, the extract contains the heated extraction agent and soluble components of the extraction material.

According to an embodiment, the system includes a switching valve. According to an embodiment, the system includes a bypass line. In particular, the volumetric flow control element can be configured as a switching valve for supplying the extraction agent to the bypass line. By means of the switching valve, the extraction agent can be diverted into the bypass line, which leads past the heating device. According to this embodiment, the extraction agent is not heated or is only heated when the switching valve is in a position which opens the path from the supply line to the bypass line. The switching valve can be configured for example as a 3/2-way valve.

According to an embodiment, the brewing device can comprise a pressure vessel. The extraction process can be performed at a pressure which is above ambient pressure.

The brewing device can contain a distribution element for distributing the extraction agent onto the extraction material. The distribution element can be configured as a shower head.

A method for producing an extract from an extraction material by means of an extraction agent comprises a system containing a supply line for the extraction agent, a heating device, a brewing device, and an extract collection container, wherein the brewing device contains the extraction material. The extraction agent is fed to the heating device via the supply line. The extraction agent is heated in the heating device. The heated extraction agent is passed by means of a connection line from the heating device to the brewing device, wherein an extract is obtained by contacting the heated extraction agent with the extraction material, which contains the extraction agent and soluble components of the extraction material. The extract is collected in the extract collection container. The supply line or the connection line contain a measuring element and a volumetric flow control element. A control unit is provided which contains at least one dosage regimen for the heated extraction agent for the brewing device. The dosage regimen is selected by means of an input device, wherein the volumetric flow control element is set according to the dosage regimen and is monitored via the measuring element.

According to an embodiment, the volumetric flow of the extraction agent, which is converted into the heated extraction agent by the heating device, can be recorded by means of a flow measuring device.

According to an embodiment, the pressure of the extraction agent is measured by means of a pressure measuring device. The volumetric flow control element can in particular contain at least one volumetric flow control element selected from the group consisting of a control valve, a switching valve, a pump, or a multi-way valve.

According to an embodiment, the control unit comprises a computing unit, a comparison unit, and a memory unit. The memory unit can contain a plurality of dosage regimens which contain the desired volumetric flows, pressures, and the desired temperatures of the extraction agent for the production of the extract. One of the dosage regimens can be selected by means of an input device which comprises the desired volumetric flow or pressure or the desired temperature of the heated extraction agent.

According to an embodiment, the measured volumetric flow value is compared with the desired volumetric flow, or the measured pressure value is compared with the desired pressure by means of the control unit. The control unit can comprise a computing unit, a comparison unit, and a memory unit.

The opening time of the control valve is determined from the desired volumetric flow by means of the computing unit. According to an embodiment, the measured volumetric flow value is compared with the desired volumetric flow or the measured pressure value is compared with the desired pressure by means of the comparison unit, so that the control valve or the multi-way valve can be set in such a way that the desired volumetric flow corresponds to the measured volumetric flow value or the desired pressure corresponds to the measured pressure value.

In particular, the control valve can be controlled by the control unit in such a way that the control valve is closed when the volume of the extraction agent corresponds to the heated extraction agent which is fed to the brewing device.

According to an embodiment, the brewing device has a distribution element for distributing the heated extraction agent onto the extraction material.

According to an embodiment, the pressure of the heated extraction agent in the brewing device is increased.

According to an embodiment, a portion of the extraction agent is not passed through the heating device.

According to an embodiment, at least a portion of the extraction agent is fed into a bypass line by actuating a switching valve, which bypasses the heating device to the brewing device or the extract collection container.

The system according to one of the preceding embodiments can be used to produce a hot beverage. The method according to one of the preceding embodiments can be used to produce a hot beverage.

The invention further comprises a method for controlling the temperature and the duration of a brewing process by means of a system which contains a heating device and a brewing device.

The system described above and the associated method make it possible to produce extracts, in particular hot beverages, with different volumes and temperature profiles as well as pauses and thus to optimize the taste of the hot beverage. In particular, a plurality of phases with appropriately controlled volumes can be implemented with the system according to the invention. Not only the volume can be controlled, but also the volumetric flow or the pressure. Therefore, a defined volumetric flow with a defined temperature and/or a defined pressure can be supplied at any point in time. The deviations of the temperature of the heated extraction agent from the target temperature, which is specified in the corresponding dosage regimen, habitually amount to a maximum of 2 degrees Celsius. The deviations of the actual volumetric flow from the desired volumetric flow amount to a maximum of 1 ml/s.

Using the system and method described above, extracts, for example hot beverages, can be produced without preheating time. The system and method described above thus make it possible to produce extracts, for example hot beverages, with a minimal expenditure of energy.

The system according to one of the embodiments does not require a storage facility for the extraction agent, which is to say in particular no extraction agent tank is required, for example a water tank, if the extraction agent is water. Any connection to a water pipe is sufficient as a water supply for the system. The above-described system and method in particular enable the preparation of a wide variety of hot beverages such as coffee, tea, and soups, rained and brewed or extracted under pressure.

### BRIEF DESCRIPTION OF THE DRAWINGS

The system according to the invention is illustrated below with the aid of a few exemplary embodiments. It is shown in

FIG. 1 a system according to a first embodiment,

FIG. 2 a system according to a second embodiment,

FIG. 3 a system according to a third embodiment,

FIG. 4 a first example of a dosage regimen,

FIG. 5 a second example of a dosage regimen,

FIG. 6 a system according to a fourth embodiment,

FIG. 7 a third example of a dosage regimen,

FIG. 8 a fourth example of a dosage regimen.

### DETAILED DESCRIPTION OF THE DRAWINGS

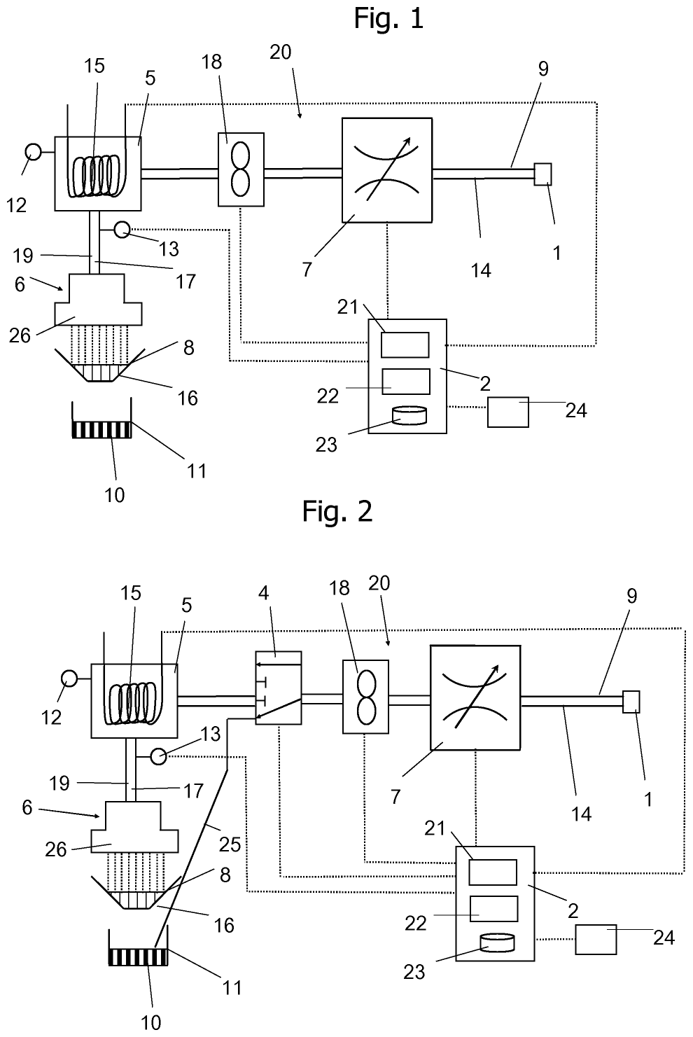

FIG. 1 shows a system 20 for producing an extract 10 from an extraction material 8 by means of an extraction agent 9, comprising a supply line 14 for the extraction agent 9, a heating device 5, a brewing device 6, and an extract collection container 11. If the system is to be used to produce a hot beverage, the extraction agent 9 can be water. The supply line 14 is connected to a water connection 1 for this application. The water connection 1 can be designed as a reservoir, tank or as a water pipe. The water connection 1 can optionally contain a water treatment system, for example a decalcifying system. The pressure of the extraction agent 9 in this range is in the range of between one and two bar; the pressure can essentially correspond to the pressure that is provided in the water pipe.

The supply line 14 is configured to supply the extraction agent 9 to the heating device 5. According to the present embodiment, the heating device 5 contains heating elements 15 for heating the extraction agent 9. A temperature measuring device 12 can be provided to determine the temperature prevailing in the heating device 5. The temperature measuring device 12 can comprise a temperature sensor or temperature capturing device.

A connection line 17 is provided for conducting the heated extraction agent 19 from the heating device 5 to the brewing device 6. A temperature measuring device 13 can be arranged in the connection line 17, preferably directly at the connection thereof to the heating device 5.

The brewing device 6 contains the extraction material 8. The brewing device 6 contains a receiving element 16 for the extraction material 8, which is permeable to the heated extraction agent 19, so that the extract 10 can be obtained by contact of the heated extraction agent 19 with the extraction material 8. The extract collection container 11 is configured to collect the extract 10. The extract collection container 11 can in particular comprise a cup for receiving a hot beverage.

A flow measuring device 18 for determining a measured value for the volumetric flow of the extraction agent 9 is arranged in the supply line 14. The flow measuring device 18 can be arranged at any desired position upstream of the heating device 5. The supply line 14 contains a control valve 7. The volumetric flow of the extraction agent 9 can be changed by means of the control valve 7. The control valve 7 can in particular be configured as a proportional valve. The flow measuring device 18 can be arranged downstream or upstream of the control valve 7. The control valve 7 can also be used for metering the extraction agent 9 and can be closed again after the corresponding opening time for the addition of a predetermined volume thereof has elapsed. The opening time is understood here to be a time duration or period in which the control valve 7 is at least partially open, so that the extraction agent 9 can flow to the heating device 5.

The system 20 contains a control unit 2, by means of which the volumetric flow of the extraction agent 9, as well as the temperature of the heated extraction agent 19 and the heat supply to the heating device 5 can be controlled. The control unit 2 comprises a computing unit 21, a comparison unit 22 and a memory unit 23. The memory unit 23 contains a plurality of dosage regimens which contain the desired volumetric flows and the desired temperatures of the extraction agent 9 for the production of the extract 10.

One of the dosage regimens can be selected by means of an input device 24, which includes the desired volumetric flow and the desired temperature of the heated extraction agent 19. By means of the computing unit 21, the opening time of the control valve 7 can be determined from the desired volumetric flow. By means of the comparison unit 22, the measured volumetric flow value can be compared with the desired volumetric flow, so that the control valve 7 can be set in such a way that the desired volumetric flow matches the measured volumetric flow value.

The extraction material 8 can be arranged in or on a receiving element 16, which can be configured as a filter, bag, or pad to be used for preparing a hot beverage.

The system can comprise a distribution element 26 for distributing the extraction agent 9 onto the extraction material 8. The distribution element 26 can, for example, be configured as a shower head. By means of the distribution element 26, the heated extraction agent 9 can be evenly distributed over the extraction material 8. If the distribution element is designed as a filter, for example a paper filter, for an extraction material to provide a hot beverage, different turbulences arise in the filter at different flow rates, which can result in different flavorings of the extract.

FIG. 2 shows a system according to a second embodiment, whereby the same reference numerals are used as in FIG. 1 for units, components or elements that are the same or have the same effect. In the following, only the differences with respect to the first embodiment according to FIG. 1 are described, otherwise, reference is made at this point to the description of FIG. 1, which should also apply to the same or identically acting units, components, or elements of this embodiment.

The system 20 according to FIG. 2 differs from the system 20 according to FIG. 1 in that it comprises a switching valve 4. The switching valve 4 is arranged in the supply line 14 between the control valve 7 and the heating device 5. As in the present illustration, it can be arranged between the flow measuring device 18 and the heating device 5; according to an embodiment not shown, it could also be arranged between the control valve 7 and the flow measuring device 18. The switching valve 4 is configured, for example, as a multi-way valve. In a first position of the switching valve 4, the connection between the control valve 7 and the heating device 5 is open, so that the extraction agent 9 can flow into the heating device 5. In a second position of the switching valve 4, the connection between the control valve 7 and the heating device 5 is closed and instead a connection between the control valve 7 and the extract collection container 11 is opened. This connection is shown as a bypass line 25.

Thus, according to this embodiment, at least a portion of the extraction agent 19 is not passed through the heating device 5. In particular, by actuating the switching valve 4, at least a portion of the extraction agent 9 is fed into a bypass line 25, so that the extraction agent 9 is conducted past the heating device 5 to the extract collection container 11.

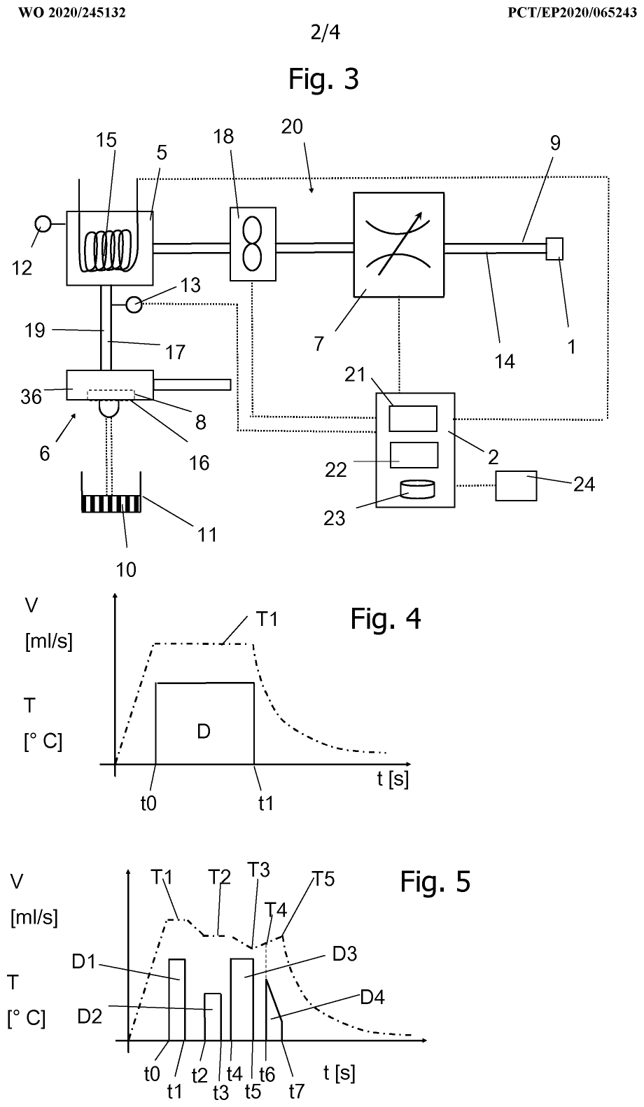

FIG. 3 shows a system 20 according to a third embodiment, whereby the same reference numerals as in FIG. 1 are used for units, components or elements that are the same or have the same effect. In the following, only the differences to the first embodiment according to FIG. 1 are described, otherwise, reference is made at this point to the description of FIG. 1, which should also apply to the same or identically acting units, components, or elements of this embodiment.

According to FIG. 3, the brewing device 6 comprises a pressure vessel 36. The extraction material 8 is arranged in the interior of this pressure vessel 36 and is shown schematically. A pressure-increasing means for the extraction agent 9, for example a pump, can be provided in the supply line 14. The supply line 14, the heating device 5, the connection line 17 and the brewing device 6 form a closed system so that, apart from line losses, no pressure losses occur in the system and the pressure of the heated extraction agent 19 essentially corresponds to the pressure applied by means of the pressure-increasing means. The extraction material 8 can be arranged in or on a receiving element 16, which can be configured as a portafilter, capsule, bag, or pad for use in preparing a hot beverage. For the preparation of a hot beverage, the pressure is usually in a pressure range from 6 to 10 bar.

According to each of the embodiments, the extraction agent 9 can also be metered by means of the control valve 7. For this purpose, the control valve 7 can be controlled by the control unit 2 in such a way that the control valve 7 is closed when the measured value of the volumetric flow corresponds to the portion of the heated extraction agent 19 required in a certain phase of the extraction process that is to be supplied to the brewing device 6. A dosage regimen for metering the extraction agent 9 can comprise a single phase or a plurality of phases.

FIG. 4 shows a diagram for a dosage regimen according to which the extraction agent 9 is heated in a single phase. The diagram contains a time axis as the abscissa, on which the time t is plotted in seconds (s). The ordinate contains two different quantities, on the one hand the volumetric flow (ml/s) and on the other hand the temperature (° C.). The volumetric flow is shown with a continuous line, the temperature with a dash-dotted line, in order to be able to differentiate the two quantities more easily from one another. The volumetric flow is constant according to this dosage regimen. This means that the control valve 7 is opened at time t0, the opening width is kept constant and is closed again at time t1. The difference t1−t0 corresponds to the opening time of the control valve 7. The area of the volumetric flow shown as a rectangle corresponds to the metered volume D of the extraction agent 9. The point in time t0 is dimensioned such that the heating device 5 can be heated to the heating temperature T1 before the control valve 7 is opened. As soon as the heating device 5 has reached the heating temperature T1, that is to say at time t0 in the present illustration, the control valve 7 is opened. The heating temperature T1 remains constant until time t1. If the control valve is closed again at time t1, the heating temperature T1 drops because the heating device cools down. A further supply of energy to the heating device 5 is no longer necessary, so that no additional energy is required in the standby state.

FIG. 5 shows an exemplary example of a dosage regimen according to which the extraction agent 9 is heated in several phases. In a first phase, which takes place in a time segment that lasts from a point in time t0 to t1, the first volume D1 of the extraction agent 9 can be heated to a temperature T1. A heating phase is provided before time t0, in which the heating device 5 is preheated to the temperature required to obtain the temperature T1. If a flow heater is used as the heating device, the temperature of the heating device 5 for the flow heater, which is detected by the temperature measuring device 12, essentially corresponds to the temperature T1 of the heated extraction agent 19, which is measured by the temperature measuring device 13.

In a second phase, which runs in a time segment that lasts from a point in time t1 to t2, the control valve 7 is closed, so that no extraction agent 9 is passed to the heating device 5. The supply of heat to the heating device 5 is also interrupted, so that a cooling to temperature T2 takes place in the second phase. The heated extraction agent 19 is passed to the brewing device 6 during the second phase and comes into contact with the extract 10. If the extract 10 is in the form of a powder or a solid containing pores, the heated extraction agent 19 fills the pores in the second phase which persist between the grains of the powder or that persist in the solid. The extract 10 is moistened by the heated extraction agent 19 in this second phase.

In a third phase, which runs in a time segment that lasts from a point in time t2 to t3, the control valve 7 is opened again so that a second volume D2 of the extraction agent 9 can be heated to a temperature T2. According to the present example, the temperature T2 differs from the temperature T1. According to this example, the temperature T2 is lower than the temperature T1. According to an embodiment not shown, the temperature T2 could also be higher than the temperature T1. In the third phase, the volumetric flow is also smaller than in the first phase. The heat requirement for the heating device 5 is adapted accordingly. In the present example, the opening time t3−t2 essentially corresponds to the opening time t1−t0; these opening times can also differ from one another. The closing time t2−t1 between the opening times can correspond to at least one of the opening times or can differ from the opening times.

In the fourth phase, which runs in a time segment that lasts from a point in time t3 to t4, the control valve 7 is closed so that no extraction agent 9 is passed to the heating device 5. In this example, the closing time t4−t3 is shorter than the previous opening time t3−t2. During this brief period of time, the temperature can remain essentially constant, that is to say it can continue to be at the temperature T2.

In a fifth phase, which runs in a time segment that lasts from a point in time t4 to t5, the control valve 7 is opened again, so that a third volume D3 of the extraction agent 9 can be heated to a temperature T2, which during the opening time to a temperature T3 is lowered. According to the present example, the heating thus takes place with a negative temperature gradient. The heated extraction agent 19 has the temperature T2 at time t4. At time t5, the heated extraction agent 19 has the temperature T3. The temperature profile is linear in the present example, but it could also have a non-linear profile. According to an embodiment not shown, the temperature T3 could also be higher than the temperature T2. In the fifth phase, the volumetric flow is also greater than in the third phase. The heat requirement for the heating device 5 is adapted accordingly. In the present example, the opening time t5−t4 is longer than the opening time t1−t0.

In the sixth phase, which follows on from the fifth phase and which expires in a time segment that lasts from time t5 to t6, the control valve 7 is closed so that no extraction agent 9 is passed to the heating device 5. In this example, the closing time t6−t5 is shorter than the previous opening time t5−t4. During this brief period of time, the temperature is increased since a higher temperature is required for the subsequent seventh phase.

In a seventh phase, which runs in a time segment that lasts from a point in time t6 to t7, the control valve 7 is opened again so that a fourth volume D4 of the extraction agent 9 can be heated to a temperature T4 up to a temperature T5. The temperature is thus increased from the temperature T4 to the temperature T5 during the opening time t7−t6. According to the present example, the heating thus takes place with a positive temperature gradient. The heated extraction agent 19 has the temperature T4 at time t6. At the point in time t7, the heated extraction agent 19 has the temperature T5. The temperature profile is linear in the present example, but it could also have a non-linear profile. In the seventh phase, the volumetric flow is also changed. The heat requirement for the heating device 5 is adapted accordingly. According to the present example, the volumetric flow decreases from time t6 to time t7. For this purpose, the opening cross section of the control valve 7 is continuously or gradually reduced.

FIGS. 4 and 5 show only by way of example two examples for a large number of possible dosage regimens. Each of the dosage regimens can be stored in the memory unit 23 in order to be carried out when required by the instruction of a user.

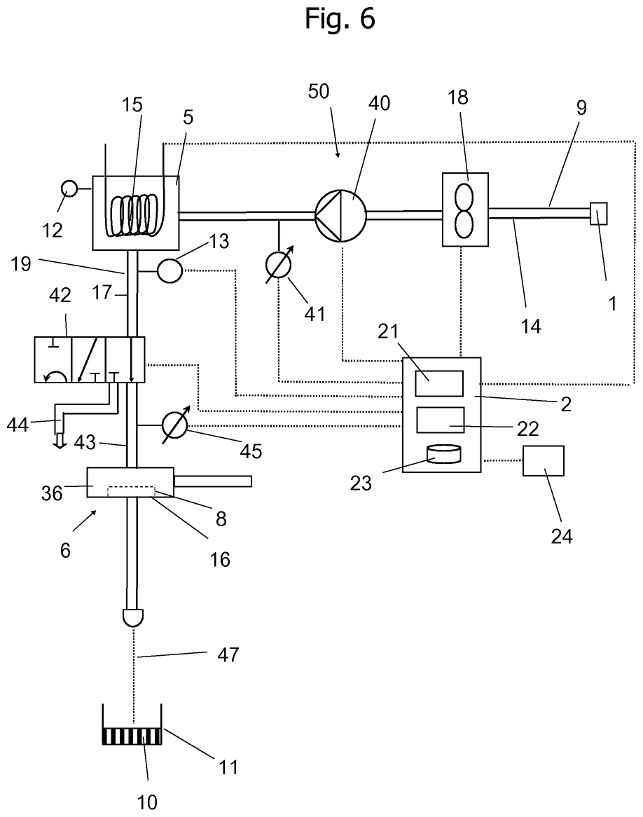

FIG. 6 shows a system 50 according to a fourth embodiment, whereby the same reference numerals are used as in FIG. 1 for units, components or elements that are the same or have the same effect. In the following, only the differences from the first embodiment according to FIG. 1 are described, otherwise, reference is made at this point to the description of FIG. 1, which should also apply to the same or identically acting units, components, or elements of this embodiment.

According to FIG. 6, the brewing device 6 comprises a pressure vessel 36. The extraction material 8 is arranged in the interior of this pressure vessel 36 and is therefore shown schematically. A pressure-increasing means for the extraction agent 9, for example a pump 40, is provided in the supply line 14. The supply line 14, the heating device 5, the connection line 17 and the brewing device 6 form a closed system so that, apart from line losses, no pressure losses occur in the system and the pressure of the heated extraction agent 19 essentially corresponds to the pressure applied by means of the pressure-increasing means. The extraction material 8 can be arranged in or on a receiving element 16, which can be designed as a portafilter, capsule, bag, or pad for use in preparing a hot beverage. For the preparation of a hot beverage, the pressure is usually in a pressure range from 5 to 20 bar.

According to the present embodiment, a pressure sensor 41 is provided in the supply line 14 between the pump 40 and the heating device 5. The pressure generated by the pump 40 can be measured by means of the pressure sensor 41. The measured pressure value determined by the pressure sensor 41 is transmitted to the control unit 2. In addition, the pump can contain an angular velocity sensor or a flow measuring device, by means of which the volumetric flow flowing through the pump or the throughput can be determined. The corresponding measured value for the angular velocity, the volumetric flow or the throughput can also be transmitted to the control unit 2. According to this embodiment, the flow measuring device 18 is thus located directly on the pump 40 and not upstream of the pump 40, as shown in FIG. 6 as a possible variant. Of course, the flow measuring device 18 can also be located upstream of the pump 40.

Optionally, the extraction agent 9 can be metered by means of a control valve 7 in a manner analogous to the variants shown in FIGS. 1 to 3. For this purpose, the control valve 7 can be controlled by the control unit 2 in such a way that the control valve 7 is closed when the measured value of the volumetric flow corresponds to the portion of the heated extraction agent 19 required in a certain phase of the extraction process that is to be supplied to the brewing device 6. A dosage regimen for metering the extraction agent 9 can comprise a single phase or a plurality of phases. The control valve can in particular be configured as a proportional valve.

The use of a pressure-increasing means for the extraction agent 9 in the supply line 14 enables the generation of a flow profile or a plurality of flow profiles which are superimposed by minimum pressure profiles or maximum pressure profiles. That is, by setting the pump 41 or the control valve 7, different pressures or volumetric flows can be set accordingly. The pressures or volumetric flows can be changed during the duration of an extraction process, which is to say the extraction process can comprise several phases, each of the phases being able to be characterized by a different pressure or volumetric flow.

This means that the volume flow or the pressure in the supply line 14 downstream of the pressure-increasing means can be changed during the duration of an extraction process. As a result, the volumetric flow or pressure in the connection line 17 can also be changed.

Optionally, a multi-way valve 42 can be arranged in the connection line 17. The multi-way valve 42 is located between the heating device 5 and the brewing device 6. According to the present embodiment, the multi-way valve 42 has three different combinations of fluid connections, it is thus configured as a three-way valve. According to this embodiment, the multi-way valve 42 has three different positions and three fluid lines. One of these fluid lines is the connection line 17 through which heated extraction agent 19 can be supplied to the multi-way valve 42. Another, second fluid line is the connection line 43, through which the heated extraction agent 19 can be fed to the brewing device 6. A third fluid line can be provided, which is configured as a wastewater line 44 in order to supply the heated extraction agent 19 to a wastewater container or sewer.

In the first position of the multi-way valve 42, the connection line 17 is connected to the connection line 43 for carrying out an extraction process. The connection to the wastewater line 44 is interrupted in the first position, so that the wastewater line 44 does not receive any heated extraction agent 19. In the second position of the multi-way valve 42, the connection line 17 is connected to the sewage line 44. The connection to the connection line 43 is interrupted in the second position, so that the connection line 43 is not supplied with any heated extraction agent 19. In the second position, the connection line 17 and the supply line 14 can be flushed. This can be advantageous in order to preheat the connection line 17 and the multi-way valve 42 with heated extraction agent 19 in order to set the temperature precisely for a subsequent extraction. Therefore, optimal temperature conditions for the extraction can be obtained. In particular, any temperature profiles can be set exactly, in particular by means of the control unit 2.

In the third position of the multi-way valve 42, a connection between the connection line 43 and the sewage line 44 can be established. The connection to the connection line 17 is interrupted in the third position. A pressure in the pressure vessel 36 that is still higher than that of the surroundings can be reduced particularly at the end of an extraction.

The multi-way valve 42 can comprise two or three of the positions described, that is, a two-way valve can alternatively be provided instead of the three-way valve shown.

The brewing device 6 contains the extraction material 8. The brewing device 6 contains a receiving element 16 for the extraction material 8, which is permeable to the heated extraction agent 19, so that the extract 10 can be obtained by contact of the heated extraction agent 19 with the extraction material 8. The extract 10 leaves the brewing device via the discharge 47 in order to fill an extract collection container 11 at least partially. The extract collection container 11 is configured to collect the extract 10. The extract collection container 11 can in particular comprise a cup for receiving a hot beverage.

The pressure prevailing in the connection line 43 can be measured by means of a pressure measuring device 45. The measured pressure value can be transmitted to the control unit 2. The pressure measurement value determined with the pressure measuring device 45 can be used by means of the computing unit 21 located in the control unit 2 and the comparison unit 22 to superimpose the pressure profile which characterizes the extraction process.

The extraction process can thus be controlled as required by means of the control unit, because different flow rates, pressures, temperatures and pauses between individual phases of brewing or extraction can be set.

According to the present embodiment, the connection line 17, the multi-way valve 42, the connection line 43, the brewing device 6, the valve 46 and the discharge 47 can be preheated by means of heated extraction agent if there is no extraction material 8 in the brewing device. Thus, during the actual extraction process, there is no or only insignificant cooling of the heated extraction agent until it reaches the extraction material 8. Therefore, the temperature of the heated extraction agent can be precisely adjusted, so that an improved temperature stability can be obtained during the extraction process.

According to each of the embodiments, the extraction material 8 can be extracted with a pressure that is essentially the same for the entire extraction material 8, thus, a more uniform extraction can be performed with improved mass transfer from the extraction material 8 into the heated extraction agent 19, so that the concentration of the soluble components of the extraction material in the extract 10 is increased.

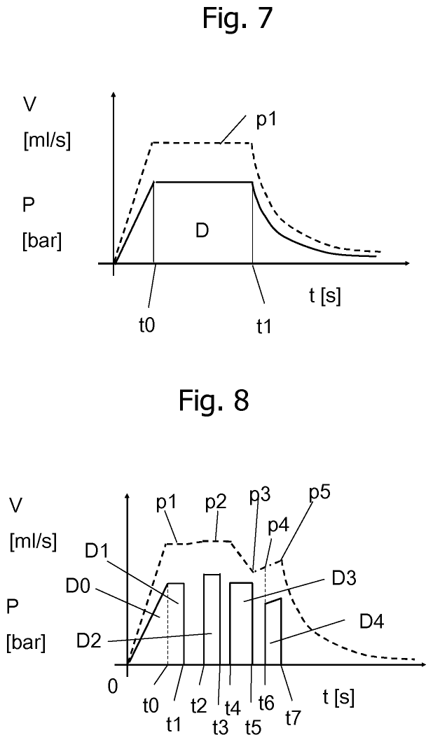

FIG. 7 shows a diagram for a dosage regimen according to which the extraction agent 9 is fed to the brewing device 6 according to FIG. 6 with a single predetermined pressure. The temperature profile should correspond to the temperature profile shown in FIG. 4. The diagram contains a time axis as the abscissa, on which the time t is plotted in seconds (s). The ordinate contains two different quantities, on the one hand the volumetric flow (ml/s) and on the other hand the pressure (bar). The volumetric flow is shown with a continuous line, the pressure with a dashed line, in order to be able to differentiate the two quantities more easily from one another. The volumetric flow is constant according to this dosage regimen, that is, the pump 40 delivers a constant volumetric flow. This means that the pump generates an increasing volumetric flow up to time t0, then the volumetric flow is kept constant by the pump and generates a decreasing volumetric flow at time t1. The difference t1−t0 corresponds to the duration of the brewing process. The area of the volumetric flow shown as a rectangle corresponds to the volume D of the extraction agent 9 during the brewing process.

The flow measuring device 18 can be used to determine whether the pressure in the supply line upstream of the pump 40 is constant. If necessary, the volumetric flow conveyed by the pump and its pressure can also be controlled as a function of the measured value determined by the flow measuring device 18. Alternatively, the volumetric flow that the pump 40 delivers can also be set by controlling the angular velocity of the pump 40. FIG. 7 shows a linearly increasing volumetric flow and a volumetric flow decreasing according to an exponential function. The pressure and the volumetric flow can be changed as desired depending on the setting of the pump 40, so that other courses are also conceivable which are not shown in the drawing.

The point in time t0 is dimensioned such that the heating device 5 can be heated to the heating temperature T1 before the pump 40 is operated in such a way that a constant volumetric flow can be generated. As soon as the heating device 5 has reached the heating temperature T1, thus, at time t0 in the present illustration, the multi-way valve is opened, that is to say the feed to the brewing device 6 is opened. The heating temperature T1 remains constant until time t1. When the multi-way valve is closed again at time t1, the heating device 5 can be switched off. Therefore, the heating temperature T1 decreases because the heater cools down. A further supply of energy to the heating device 5 is no longer necessary, so that no additional energy is required in the standby state.

FIG. 8 shows an exemplary example of a dosage regimen according to which the extraction agent 9 is fed to the brewing device 6 in several phases. A start phase of the pressure increase is provided before the point in time t0 when the pump 40 is put into operation. In this start phase, the volumetric flow increases. The multi-way valve 42 can be in the third position in order to build up pressure in the connection line 17 or in the second position in order to direct insufficiently preheated water into the line 44 leading to the wastewater. In this start phase, which runs in a time segment that lasts until time t0, the heating device 5 can be supplied with a volume D0 of the extraction agent 9 at an increasing pressure, which increases up to pressure p1. During the period t0−0 the volumetric flow increases; a volume D0 (ml) is conveyed, which is symbolized by the triangular area under the volumetric flow curve.

In a first phase, which runs in a time segment that lasts from a point in time t0 to t1, the multi-way valve 42 is in the first position, so that extraction agent 9 is passed through the heating device 5 into the connection line 17, through the multi-way valve 42 into the connection line 43 to the brewing device 6. The pump 40 remains in operation and the heating device 5 remains switched on as long as the heated extraction agent 19 is required to have the appropriate temperature for the brewing device 6. The supply of heat to the heating device 5 can also be interrupted if cooling is to take place in the first phase. During the period t1−t0 the volumetric flow is constant, a volume D1 (ml) is conveyed, which is symbolized by the rectangular area under the volumetric flow curve.

In a second phase, which runs in a time segment that lasts from a point in time t1 to t2, the multi-way valve 42 is in the second or third position, so that extraction agent 9 is not passed through the heating device 5 into the connection line 17 to the multi-way valve 42, but from the connection line 43 to the brewing device 6. The pump 40 is switched off and the heating device 5 remains switched on so that the extraction agent can reach the temperature required for the brewing device 6. The pressure can thus increase as a result of the heating of the extraction agent 9; according to the present embodiment, the pressure is p2 at time t2 and p1 at time t1. The pressure p2 is slightly higher than the pressure p1.

In a third phase, which runs in a time segment that lasts from a point in time t2 to t3, the multi-way valve 42 is in the first position, so that extraction agent 9 passes through the heating device 5 into the connection line 17 to the multi-way valve 42 and from the connection line 43 to the brewing device 6. The heated extraction agent 19 is thus conducted to the brewing device 6 during the third phase and comes into contact with the extract 10. If the extract 10 is in the form of a powder or a solid containing pores, the heated extraction agent 19 fills the pores in the third phase, that persist between the grains of the powder or that persist in the solid. The extract 10 is moistened by the heated extraction agent 19 in this third phase.

In the third phase, which runs in a time segment that lasts from a point in time t2 to t3, the pump 40 is switched on again or the volumetric flow is changed in such a way that a second volume D2 of the extraction agent 9 can be brought to a pressure p2 or maintained at the pressure p2. According to the present example, the pressure p2 differs from the pressure p1. According to this example, the pressure p2 is higher than the pressure p1. According to an embodiment not shown, the pressure p2 could also be lower than the pressure p1. In the third phase, the volumetric flow is also greater than in the first phase. The heat requirement for the heating device 5 can be adapted accordingly. In the present example, the opening time t3−t2 essentially corresponds to the opening time t1−t0; these opening times can also differ from one another according to an embodiment that is not shown. The closing time t2−t1 between the opening times can correspond to at least one of the opening times or can differ from the opening times. During the opening time, the multi-way valve is in the first position, during the closing time it is in one of the second or third positions, so that no heated extraction agent 19 is fed to the brewing device.

In the fourth phase, which runs in a time segment that lasts from a point in time t3 to t4, the pump 40 is switched off or its speed is reduced so that no extraction agent 9 is passed to the heating device 5. In this example, the closing time t4−t3 is shorter than the previous opening time t3−t2. During this short period of time, the pressure can remain essentially constant, that is to say it can keep the value p2. The temperature of the extraction agent 9 located in the heating device 5 can be increased, since no cold extraction agent can flow in.

In a fifth phase, which runs in a time segment that lasts from a point in time t4 to t5, the multi-way valve 42 again changes to the first position, so that a third volume D3 of the extraction agent 9 is reduced from pressure p2 to pressure p3 during the opening time. According to the present example, a pressure drop occurs during the fifth phase. The heated extraction agent 19 has the pressure p2 at time t4. At the point in time t5, the heated extraction agent 19 has the pressure p3. The pressure drop is linear in the fifth phase, but the pressure drop could also have a non-linear profile. According to an embodiment not shown, the pressure p3 could also be higher than the pressure p2. In the fifth phase, the volumetric flow is also smaller than in the third phase. The heat requirement for the heating device 5 can also be adapted accordingly. The opening time t5−t4 is longer than the opening time t1−t0 in the present example.

In the sixth phase, which follows the fifth phase, and which expires in a time segment that lasts from time t5 to t6, the multi-way valve 42 is shifted to the third position so that no heated extraction agent 19 is directed to the brewing device 6. In this example, the closing time t6−t5 is shorter than the previous opening time t5−t4. During this short period of time, the pressure in the connection line 17 is increased since a higher pressure is required for the subsequent seventh phase.

In a seventh phase, which runs in a time segment that lasts from a point in time t6 to t7, the multi-way valve is again shifted to the first position so that a fourth flow rate D4 of the extraction agent 9 can be increased from a pressure p4 to a pressure p5. The pressure is thus increased from pressure p4 to pressure p5 during the opening time t7−t6. The volumetric flow of the extraction agent 9, which is conveyed by the pump 40, increases, for example by increasing the angular velocity of the pump 40. The heated extraction agent 19 has the pressure p4 at time t6. At the point in time t7, the heated extraction agent 19 has the pressure p5. In the present example, the pressure profile is linear, but it could also have a non-linear profile.

FIGS. 7 and 8 show only by way of example two examples for a large number of possible dosage regimens for controlling the extraction process. Each of the dosage regimens can be stored in the memory unit 23 in order to be carried out when required by the instruction of a user.

It is obvious to a person skilled in the art that many further variants are possible in addition to the embodiments described without deviating from the inventive concept. The subject matter of the invention is therefore not restricted by the preceding description and is determined by the scope of protection which is defined by the claims. The broadest possible reading of the claims is authoritative for the interpretation of the claims or the description. In particular, the terms “contain” or “include” are to be interpreted in such a way that they refer to elements, components, or steps in a non-exclusive meaning, which is intended to indicate that the elements, components, or steps can be present or are used that they can be combined with other elements, components or steps that are not explicitly mentioned. When the claims relate to an element or component from a group which may consist of A, B, C to N elements or components, this formulation should be interpreted in such a way that only a single element of that group is required, and not one combination of A and N, B and N, or any other combination of two or more elements or components of this group.

1. A system for producing an extract of a hot beverage from an extraction material by means of an extraction agent, comprising a supply line for a continuous supply of the extraction agent, a heating device, a brewing device, as well as an extract collection container, wherein the brewing device contains the extraction material, wherein the supply line is configured for supplying the extraction agent to the heating device, wherein a connection line is provided for the heated extraction agent from the heating device to the brewing device, wherein the brewing device contains a receiving element for the extraction material, which is permeable to the heated extraction agent, so that the extract is obtainable by contact of the heated extraction agent with the extraction material, wherein the extract collection container is configured to collect the extract, wherein the supply line or the connection line contain at least one measuring element and at least one volumetric flow control element, wherein a control unit is provided which contains at least one dosage regimen for the heated extraction agent for the brewing device, the dosage regimen being selectable by means of an input device, whereby the volumetric flow control element can be set according to the dosage regimen and is monitored via the measuring element, and wherein a heating controller for controlling a heat supply to the heating device is provided.

2. The system of claim 1, wherein an opening time of the volumetric flow control element can be determined by means of the control unit from a desired volumetric flow or the pressure.

3. The system of claim 1, wherein the control unit comprises a computing unit, a comparison unit and a memory unit, wherein the memory unit contains the dosage regimen, or a plurality of dosage regimens.

4. (canceled)

5. The system of claim 3, wherein the dosage regimen contains desired volumetric flows, desired pressures or desired temperatures of the extraction agent or the heated extraction agent for a production of the extract.

6. The system of claim 5, wherein a measured volumetric flow value can be compared with a desired volumetric flow by means of the comparison unit or wherein a measured pressure value can be compared with the desired pressure by means of the comparison unit or wherein a measured temperature value can be compared with the desired temperature by means of the comparison unit or wherein an extraction process for a desired volumetric flow can be extrapolated from extraction processes with known volumetric flows.

7-9. (canceled)

10. The system of claim 3, wherein the desired volumetric flow can be added as a disturbance variable.

11. The system of claim 1, wherein the measuring element is configured as a flow measuring device for determining a measured volumetric flow value or a pressure measuring device for determining a measured pressure value or a temperature measuring device for determining a measured temperature value of at least one of the extraction agent or of the heated extraction agent.

12. The system of claim 1, wherein the volumetric flow control element is configured as a two-way valve, a control valve, a multi-way valve or a pump, or wherein the supply line contains the control valve or the pump or wherein the connection line contains the multi-way valve.

13. (canceled)

14. (canceled)

15. The system of claim 12, wherein the pump is configured as a controllable pump.

16. (canceled)

17. The system of claim 1, wherein the brewing device comprises a pressure vessel.

18. The system of claim 1, further comprising a distribution element for distributing the extraction agent onto the extraction material.

19. A method for producing an extract of a hot beverage from an extraction material by means of an extraction agent, comprising a system containing a supply line for the extraction agent, a heating device, a brewing device, and an extract collection container, wherein the brewing device contains the extraction material, wherein the extraction agent is fed to the heating device via the supply line, wherein the extraction agent is heated in the heating device to form a heated extraction agent, wherein the heated extraction agent is conducted from the heating device to the brewing device by means of a connection line, wherein an extract is obtained by contact of the heated extraction agent with the extraction material which contains the extraction agent and soluble components of the extraction material, wherein the extract is collected in the extract collection container, wherein the supply line or the connection line contain a measuring element and a volumetric flow control element, wherein a control unit is provided which contains at least one dosage regimen for the heated extraction agent for the brewing device, the dosage regimen is selected by means of an input device, wherein the volumetric flow control element is set according to the dosage regimen and is monitored via the measuring element wherein a heating controller controls a heat supply to the heating device.

20. The method of claim 19, wherein the volumetric flow of the extraction agent, which is converted by the heating device into the heated extraction agent, is recorded by means of a flow measuring device.

21. The method of claim 19, wherein a pressure of the extraction agent is measured by means of a pressure measuring device.

22. The method of claim 19, wherein the volumetric flow control element contains at least one flow control element selected from the group consisting of a control valve, a switching valve, a pump or a multi-way valve, wherein the control valve or the multi-way valve can be set in such a way that a desired volumetric flow corresponds to a measured volumetric flow value or a desired pressure corresponds to a measured pressure value or a desired temperature corresponds to a measured temperature value.

23. The method of claim 22, wherein the control unit comprises a computing unit, a comparison unit, a memory unit wherein the memory unit contains a plurality of dosage regimens which contain the desired volumetric flows, pressures, and the desired temperatures of the extraction agent or the heated extraction agent for production of the extract, wherein the volumetric flow measurement value is compared with the desired volumetric flow or the pressure measurement value with the desired pressure or the temperature measurement value with the desired temperature by means of the comparison unit or wherein an extraction process for a desired volumetric flow is extrapolated from extraction processes with known volumetric flows.

24. (canceled)

25. The method of claim 22, wherein one of the dosage regimens is selected by means of the input device which comprises the desired volumetric flow or the desired pressure or the desired temperature of the heated extraction agent.

26. The method of claim 22, wherein the measured volumetric flow value is compared with the desired volumetric flow, or the measured pressure value is compared with the desired pressure, or the measured temperature value is compared with the desired temperature by means of the control unit.

27. (canceled)

28. (canceled)

29. The method of claim 19, wherein a pressure of the heated extraction agent is increased in the brewing device.

30. The method of claim 19, wherein at least part of the extraction agent is not passed through the heating device, wherein at least a portion of the extraction agent can be fed into a bypass line by actuating a switching valve, so that the extraction agent is led to the brewing device or to the extract collection container bypassing the heating device.

31. (canceled)

32. (canceled)
